(19) United States
(12) Patent Application Publication
(10) Pub. No.: US 2013/0169403 A1
(43) Pub. Date: Jul. 4, 2013

(54) MAGNETIC COMPONENT AND MANUFACTURING METHOD THEREOF

(71) Applicant: Jun SUN, Shanghai (CN)

(72) Inventor: Jun SUN, Shanghai (CN)

(73) Assignee: DELTA ELECTRONICS (SHANGHAI) CO., LTD., Shanghai (CN)

(21) Appl. No.: 13/529,405

(22) Filed: Jun. 21, 2012

(30) Foreign Application Priority Data
Dec. 31, 2011 (CN) 201110455600.3

(51) Int. Cl. H01F 5/02; H01F 27/30

(52) U.S. Cl. 336/200; 336/199; 29/602.1

(57) ABSTRACT

A magnetic component and manufacturing method thereof are described. The manufacturing method includes the following steps: (1) coating an insulation material on the surface of a magnetic core to form an insulation magnetic core; (2) bending the conducting material into a predetermined shape to form a preformed conductive body; and (3) assembling the mold conducting body with the insulation magnetic core to form a magnetic component. The method of the present invention easily manufactures the magnetic component with a shrinkage size and good insulation characteristic between the preformed conductive body and the insulation magnetic core.

### FIELD OF THE INVENTION

The present invention relates to a magnetic component and a manufacturing method thereof, and more particularly to a magnetic component and a manufacturing method thereof without the wire winding frame.

### BACKGROUND OF THE INVENTION

With the requirements of high-frequency and high-power intensity in a magnetic component, there is a need to downsize the magnetic component. Basically, the magnetic component is composed of three portions including a magnetic core, a conductive body and a wire winding frame. The magnetic core and the conductive body have electrically characteristics while the magnetic component is activated, and the wire winding frame has the functions of sustentation and insulation. Due to the miniaturization trend of the magnetic component, the removal of the wire winding frame from magnetic component is one way to downsize the magnetic component. However, after the wire winding frame is removed from magnetic component, the problems of how to perform the process of wire winding frame and how to insulate the conductive body from the magnetic core are induced. Moreover, while the wire winding frame is removed from magnetic component, the conductive body directly faces against the magnetic core. However, when the voltage between the conductive body and the magnetic core is gradually increased, the conductive body applies the larger spark current to the magnetic core, which the power supply with the magnetic component damages the machine equipped with the power supply.

Currently, some drawbacks exist in the conventional solution to the above-mentioned spark problem. For example, two cases of the spark problem are described below.

FIG. 1 is a schematic structural view of conventional conductive body 101 covered with an external casing unit 102. In FIG. 1, the casing unit 102 covers the conductive body 101 wherein the casing unit 102 serves as the insulation function. One drawback is that the contact region between the casing unit 102 and the soldering portion 103 need to be controlled precisely; otherwise, the spark between the conductive body and the magnetic core occurs. Another drawback is that the manner of covering the conductive body 101 with the casing unit 102 is only applicable to the conductive body 101 having few turn numbers and regular shape, but not applicable to the conductive body 101 having many turn numbers and irregular shape. In FIG. 2, the copper wire winding set having many turn numbers cannot use the casing unit 102 for the purpose of the insulation.

In another case, FIG. 3 is a schematic structural view of conventional magnetic component having a conductive body covered with an insulation coating. One drawback is that the contact region between the insulation coating and the soldering portion 203 need to be controlled precisely; otherwise, the spark between the conductive body and the magnetic core occurs and thus the manufacturing process of the magnetic component is too complicated if the contact region cannot be controlled exactly. Another drawback is that a contact friction between the conductive body 202 covered with the insulation coating and the magnetic core 201 is induced. The contact friction damages the insulation coating to destroy the power supply.

Consequently, there is a need to develop a proper method to solve the aforementioned spark problem of the conductive body and magnetic core therebetween without the wire winding frame.

### SUMMARY OF THE INVENTION

One objective of the present invention is to provide a magnetic component and a manufacturing method thereof for simplifying the manufacturing process of the magnetic component and forming a better insulation between the magnetic and conductive body of the magnetic component.

According to the above objective, the present invention sets forth a manufacturing method of the magnetic component, the method including the steps of:

(1) coating an insulation material on a surface of a magnetic core to form an insulation magnetic core thereon;

(2) bending a conducting material into a predetermined shape to form a preformed conductive body; and

(3) assembling the preformed conductive body with the insulation magnetic core to form the magnetic component.

In one embodiment, a surface region of the preformed conductive body may be wrapped around three insulation strip layers.

In one embodiment, a surface region of the preformed conductive body may be covered with a casing unit.

In one embodiment, a surface region of the preformed conductive body may be attached by an adhesive tape.

In one embodiment, a surface region of the preformed conductive body may be coated by the insulation material.

In one embodiment, the magnetic core may include a lead angle portion.

In one embodiment, the magnetic core may be coated with the insulation material in either a uniform thickness or a non-uniform thickness.

In one embodiment, the magnetic core may be either wholly or partly coated with the insulation material.

In one embodiment, the magnetic core may be assembled with the preformed conductive body to form a magnetic unit with a specific shape.

In one embodiment, the magnetic core comprises at least two portions.

A magnetic component includes:
a magnetic core; and
a preformed conductive body disposed in a surface region of the magnetic core, wherein an insulation material may be coated in a contact region between the magnetic and the preformed conductive body for forming an insulation magnetic core.

In one embodiment, the magnetic core comprises a lead angle portion.

In one embodiment, the magnetic core may be coated with the insulation material in either a uniform thickness or a non-uniform thickness.

In one embodiment, the magnetic core may be either wholly or partly coated with the insulation material.

In one embodiment, the magnetic core may be assembled with the preformed conductive body to form a magnetic unit with a specific shape.

In one embodiment, the magnetic core comprises at least two portions.

In one embodiment, the insulation material may be selected one group consisting of epoxy resin, magnesium oxide, aluminum oxide, quartz powder and the combinations.

A transformer apparatus includes:
a magnetic core;
a printed circuit board; and
at least one electronic unit disposed in the printed circuit board, wherein the magnetic core is disposed in the printed circuit board, and the magnetic core contacts the at least one electronic unit in a region which is coated with an insulation material.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic structural view of conventional conductive body covered with an external casing unit;

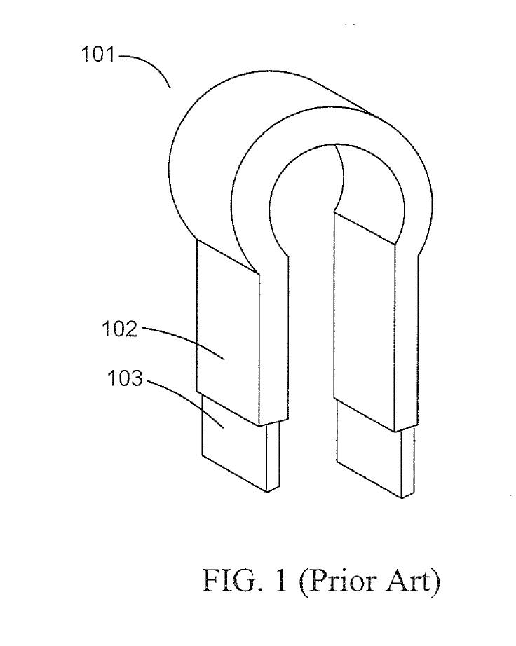

FIG. 2 is a schematic structural view of conventional copper wire winding set;

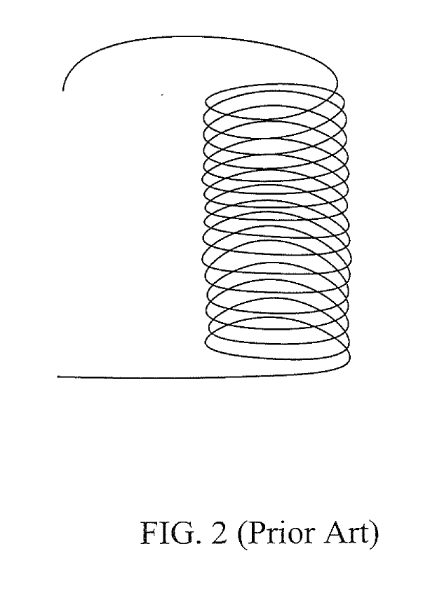

FIG. 3 is a schematic structural view of conventional magnetic component having a conductive body covered with an insulation coating;

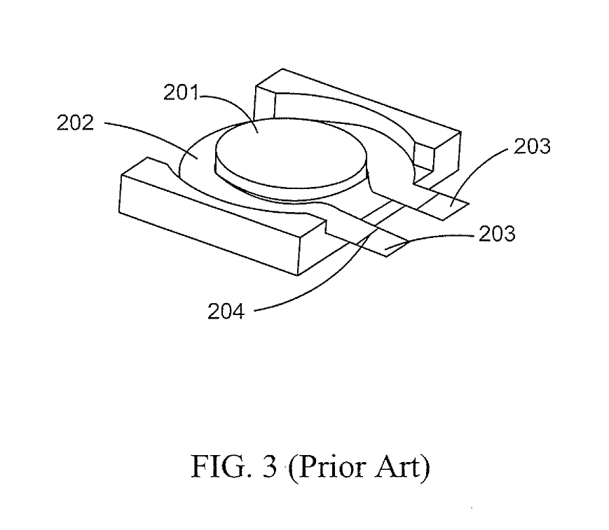

FIG. 4 is a flow chart of manufacturing a magnetic component according to one embodiment of the present invention;

FIG. 5 is a schematic exploded view of the magnetic component formed by the manufacturing method depicted in FIG. 4 according to one embodiment of the present invention;

FIG. 6 is a schematic integral structural view of the magnetic component shown in FIG. 5 according to one embodiment of the present invention;

FIG. 7 is a schematic cross-sectional view of the magnetic component along the line A-A shown in FIG. 6 according to one embodiment of the present invention; and

FIG. 8 is a schematic utilization view of the magnetic component formed by the manufacturing method depicted in FIG. 4 according to one embodiment of the present invention.

### DETAILED DESCRIPTION OF THE PREFERRED EMBODIMENTS

The embodiments of the magnetic component and the manufacturing method thereof are further described below.

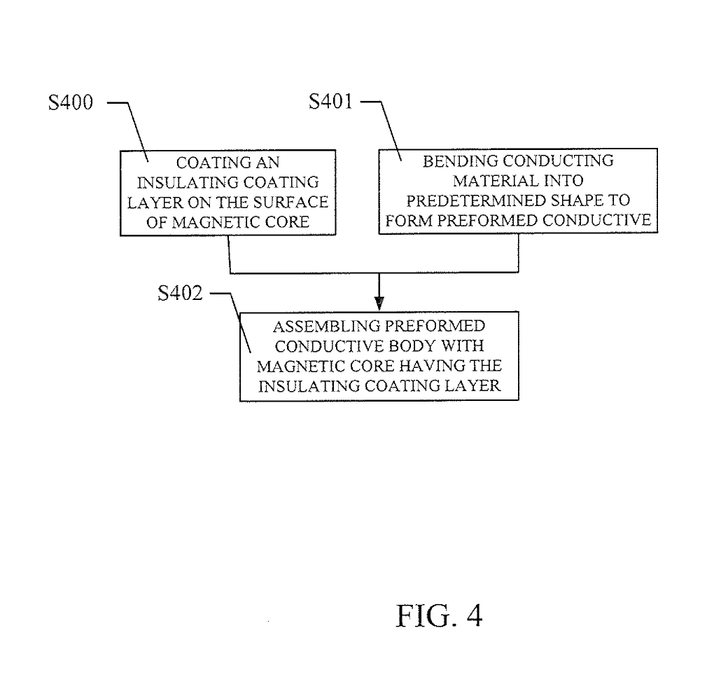

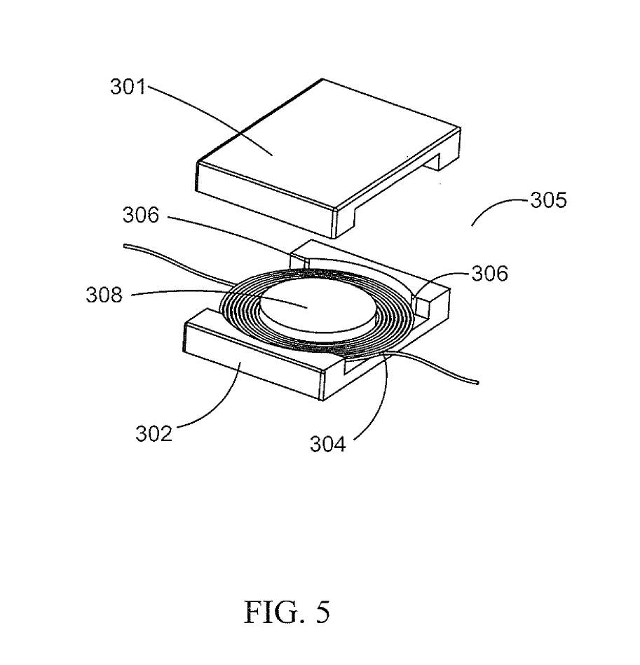

FIG. 4 is a flow chart of manufacturing a magnetic component according to one embodiment of the present invention. FIG. 5 is a schematic exploded view of the magnetic component formed by the manufacturing method depicted in FIG. 4 according to one embodiment of the present invention. Please refer to FIG. 4 and FIG. 5. The manufacturing method of a magnetic component 305 includes the following steps:

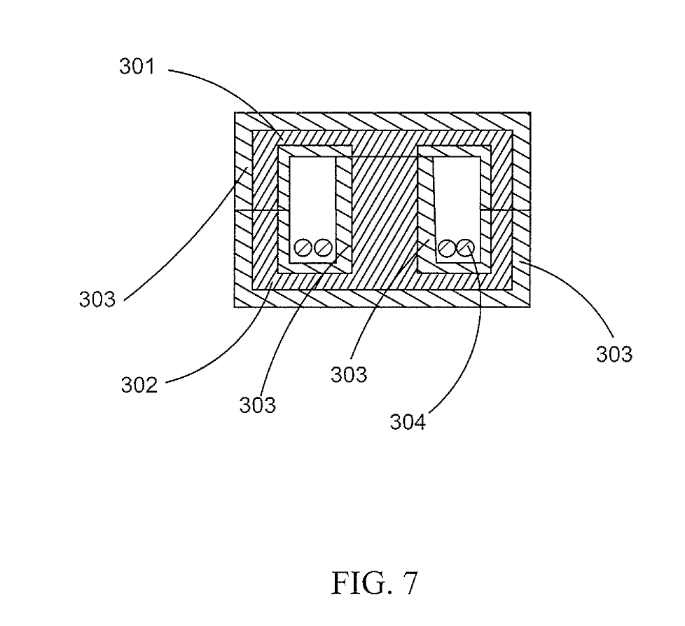

In step S400, an insulation material may be coated on a surface of the first portion 301 and the second portion 302 of a magnetic core for generating an insulating coating layer 303 (shown in FIG. 7) in order to form an insulation magnetic core 307 thereon. In one embodiment, the method for coating the insulating material includes a printing manner and/or spraying manner. Person skilled in the art should be noted that the insulating coating layer 303 may be selected one group consisting of epoxy resin, magnesium oxide, aluminum oxide, quartz powder and the combinations thereof. In one case, the coating region may be the contact region between the magnetic core and the preformed conductive body 304. In another case, the coating region may be the whole surface of the magnetic core. Further, the coating region of the insulation material may be also dependent on the user design requirement.

In step S401, a conducting material is bent to be a predetermined shape so as to form a preformed conductive body 304. For example, the conducting material may be copper for the person skilled in the art. Person skilled in the art bends conducting material to be a predetermined shape so as to form a preformed conductive body 304. In one embodiment, the copper wire may be wrapped around a copper wire winding set. In another embodiment, person skilled in the art bends conducting material to be a default shape which may be dependent on the user design requirement.

In step S402, the preformed conductive body 304 may be assembled with the insulation magnetic core 307 to form the magnetic component 305. Based on the insulation magnetic core 307 including the first portion 301 and the second portion 302 and the preformed conductive body 304, the insulation magnetic core 307 including the first portion 301 and the second portion 302 may be assembled with the preformed conductive body 304 to form the magnetic component 305 wherein an insulation material may be coated on a surface of the first portion 301 and the second portion 302 of the magnetic core. For example, if the preformed conductive body 304 may be a copper wire winding set and the central column 308 of the first portion 301 and the second portion 302 of the magnetic core may be a cylinder, the magnetic component 305 may be formed when the preformed conductive body 304 may be disposed on the surface of the central column 308 of the first portion 301 and/or the second portion 302 of the magnetic core.

In one embodiment, the surface of the preformed conductive body 304 may be covered with the insulation material. In another embodiment, an insulation layer may be adhered to the surface of the preformed conductive body 304 so that the preformed conductive body 304 having the insulation layer cooperates with the insulation magnetic core 307 to facilitate the insulation effect between the preformed conductive body 304 and the insulation magnetic core 307.

Based on the aforementioned descriptions, since the steps S400 and S401 may be performed independently, the steps S400 and S401 may be either simultaneously or sequentially performed according to the user design requirement.

FIG. 5 is a schematic exploded view of the magnetic component formed by the manufacturing method depicted in FIG. 4 according to one embodiment of the present invention. In FIG. 5, the mage core may be a core shape of “EE” including the first portion 301 and the second portion 302. In this embodiment, the insulation material may be coated on the surface of the first portion 301 and the second portion 302 of the magnetic core to form the insulating coating layer 303 (shown in FIG. 7). In one embodiment, the magnetic core may be coated with the insulating coating layer 303 in a uniform thickness. In another embodiment, the magnetic core may be coated with the insulating coating layer 303 in a non-uniform thickness. The reference numeral 304 represents the preformed conductive body 304. In this case, if the preformed conductive body 304 may be a copper wire winding set and the preformed conductive body 304 may be disposed on the surface of the central column 308, the magnetic component 305 may be formed when both the first portion 301 and the second portion 302 of the magnetic core close together. In one embodiment, the surface of the preformed conductive body 304 may be covered with the insulation material. In another embodiment, an insulation layer may be adhered to the surface of the preformed conductive body 304 so that the preformed conductive body 304 having the insulation layer cooperates with the insulation magnetic core 307 to facilitate the insulation effect between the preformed conductive body 304 and the insulation magnetic core 307.

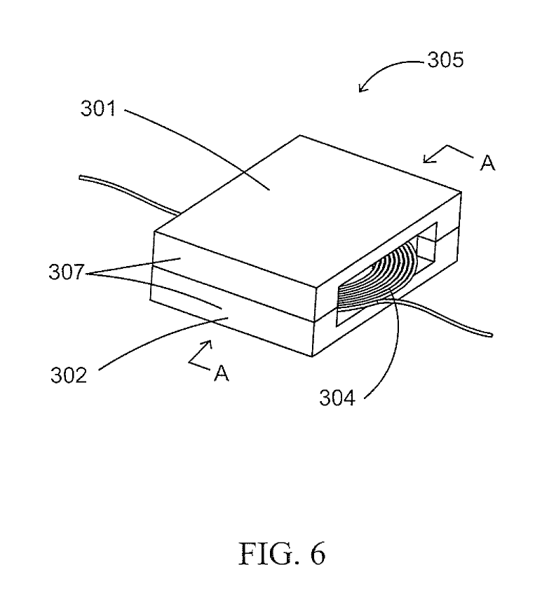

FIG. 6 is a schematic integral structural view of the magnetic component shown in FIG. 5 according to one embodiment of the present invention. In FIG. 6, the magnetic component 305 includes the magnetic core having the insulating coating layer 303 (shown in FIG. 7) wherein the magnetic core may be composed of the insulation magnetic core 307 and the preformed conductive body 304 on the surface of the magnetic core.

FIG. 7 is a schematic cross-sectional view of the magnetic component along the line A-A shown in FIG. 6 according to one embodiment of the present invention. In FIG. 7, the insulating coating layer 303 may be coated on the surface of the first portion 301 and the second portion 302 of the magnetic core for insulating the first portion 301 and the second portion 302 from the preformed conductive body 304 so that the spark effect between the conductive body and the magnetic core and the damage of the power supply are avoided.

In the present invention, the shape of the magnetic core may not by limited to form either regular or irregular shape. For example, the core shape of “EE” can be core shapes of “EI” and “UU” so that the magnetic core may be assembled with the preformed conductive body 304 to form the magnetic component having arbitrary shapes of magnetic cores.

In one embodiment, the magnetic core includes at least two portions and the insulating coating layer may be covered on the surface of the magnetic core to form the insulation magnetic core 307. The insulation magnetic core 307 and the preformed conductive body 304 form the magnetic component. In the magnetic component of the present invention, the wire winding frame may be omitted advantageously, and the spark effect between the conductive body and the magnetic core and the damage of the power supply are thus avoided. In one embodiment, the magnetic component may be either inductive component or transformer.

In one embodiment, when the edge of the magnetic core forms a sharp profile, the magnetic core includes a lead angle portion for preventing the sharp edge of the magnetic core from the integrity and completeness of the insulating coating layer 303 before coating the insulating coating layer 303. In FIG. 5, the lead angle portion 306 may be disposed in contact sharp edge between the second portion 302 of the magnetic core and the preformed copper wire winding set 304.

According to the above-mentioned descriptions, the contact region between the magnetic core and the conductive body includes the insulating coating layer to improve the spark effect between the conductive body and the magnetic core.

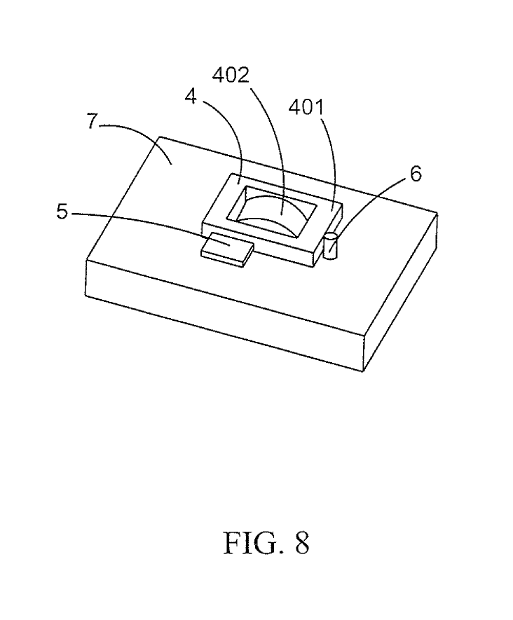

FIG. 8 is a schematic utilization view of the magnetic component formed by the manufacturing method depicted in FIG. 4 according to one embodiment of the present invention. In FIG. 8, the magnetic component 4 and the electronic units 5, 6 are disposed in the printed circuit board 7. The surface of the magnetic 401 may be coated with the insulating coating layer to form the insulation magnetic core 307 and the preformed conductive body may be disposed on the surface of the insulation Magnetic core. The contact region between the magnetic component 4 and the electronic units 5, 6 may be coated with the insulating material. If the electronic units 5, 6 contact the magnetic component 4, the electronic units 5, 6 and the magnetic component 4 are not in the electrical contact status to avoid the poor insulation condition induced by electrical contact when the surface of the magnetic core may be coated with the insulating material. It should be noted that the amount of the electronic units 5, 6 is not limited two units but can be determined by the user design requirement.

The magnetic component and a manufacturing method of the present invention simplify the manufacturing process of the magnetic component for advantageously shrinking the volume of the magnetic component. Further, the magnetic component and a manufacturing method form a better insulation between the magnetic and conductive body of the magnetic component to improve the spark effect between the conductive body and the magnetic core due to the insulating coating layer on the surface of the magnetic core.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A manufacturing method of a magnetic component, the manufacturing method comprising the steps of
coating an insulation material on a surface of a magnetic core to form an insulation magnetic core thereon;
bending a conducting material into a predetermined shape to form a preformed conductive body; and
assembling the preformed conductive body with the insulation magnetic core to form the magnetic component.

2. The manufacturing method of claim 1, wherein a surface region of the preformed conductive body is wrapped around three insulation strip layers.

3. The manufacturing method of claim 1, wherein a surface region of the preformed conductive body is covered with a casing unit.

4. The manufacturing method of claim 1, wherein a surface region of the preformed conductive body is attached by an adhesive tape.

5. The manufacturing method of claim 1, wherein a surface region of the preformed conductive body is coated by the insulation material.

6. The manufacturing method of claim 1, wherein the magnetic core comprises a lead angle portion.

7. The manufacturing method of claim 1, wherein the magnetic core is coated with the insulation material in either a uniform thickness or a non-uniform thickness.

8. The manufacturing method of claim 1, wherein the magnetic core is either wholly or partly coated with the insulation material.

9. The manufacturing method of claim 1, wherein the magnetic core is assembled with the preformed conductive body to form a magnetic unit with a specific shape.

10. The manufacturing method of claim 1, wherein the magnetic core comprises at least two portions.

11. A magnetic component, comprising:
a magnetic core; and
a preformed conductive body disposed in a surface region of the magnetic core, wherein an insulation material is coated in a contact region between the magnetic and the preformed conductive body for forming an insulation magnetic core.

12. The magnetic component of claim 11, wherein the magnetic core comprises a lead angle portion.

13. The magnetic component of claim 11, wherein the magnetic core is coated with the insulation material in either a uniform thickness or a non-uniform thickness.

14. The magnetic component of claim 11, wherein the magnetic core is either wholly or partly coated with the insulation material.

15. The magnetic component of claim 11, wherein the magnetic core is assembled with the preformed conductive body to form a magnetic unit with a specific shape.

16. The magnetic component of claim 11, wherein the magnetic core comprises at least two portions.

17. The magnetic component of claim 11, wherein the insulation material is selected one group consisting of epoxy resin, magnesium oxide, aluminum oxide, quartz powder and the combinations.

18. A transformer apparatus, comprising:
a magnetic core;
a printed circuit board; and
at least one electronic unit disposed in the printed circuit board, wherein the magnetic core is disposed in the printed circuit board, and the magnetic core contacts the at least one electronic unit in a region which is coated with an insulation material.
